(19) United States
(12) Patent Application Publication
(10) Pub. No.: US 2025/0340105 A1
(43) Pub. Date: Nov. 6, 2025

(54) HYBRID POWERTRAIN WITH VEHICLE-MOUNTED ELECTRIC MOTOR-GENERATOR

(71) Applicant: Rush Group Limited, L.L.C., Wayne, MI (US)

(72) Inventor: Aaron Rivers, Indianapolis, IN (US)

(73) Assignee: Rush Group Limited, L.L.C., Wayne, MI (US)

(21) Appl. No.: 19/200,134

(22) Filed: May 6, 2025

Related U.S. Application Data
(60) Provisional application No. 63/643,256, filed on May 6, 2024.

(51) Int. Cl. B60K 6/442; B60K 6/28; B60K 6/36; B60K 6/52; B60K 17/344; B60L 53/00; B60L 55/00; B60W 20/20

(52) U.S. Cl. CPC B60K 6/442; B60K 6/28; B60K 6/36; B60K 6/52; B60K 17/344; B60L 53/00; B60L 55/00; B60W 20/20; B60L 2260/20; B60Y 2200/92; B60Y 2300/91

(57) ABSTRACT

A hybrid powertrain with a vehicle-mounted electric motor-generator and a transfer case assembly configured to control the transfer of power from the vehicle engine and transmission and an on-board electric motor-generator to the respective driven axles is provided. The transfer case assembly allows the hybrid powertrain to be capable of operating in a variety of operating modes including modes wherein the vehicle, at idle with the engine running, may supply power or rotational torque from the engine to the onboard electric motor-generator to power to an external payload or charge an onboard storage medium, and/or while driving or in motion, the engine powers the driven axle(s), but also provides additional power or rotational torque, in excess of that required to power or drive the driven axles, to the onboard electric motor-generator, such that the electric motor-generator may supply power to or charge the onboard storage medium.

### CROSS REFERENCE TO RELATED APPLICATIONS

This application claims the benefit of U.S. Provisional Application No. 63/643,256, filed on May 6, 2024, which is hereby incorporated by reference in its entirety.

### TECHNICAL FIELD

The present disclosure generally relates to a vehicle powertrain, and more particularly a hybrid vehicle powertrain, having a unique transfer case assembly and a modular, vehicle-mounted electric motor-generator system that acts as each of a modular drive unit and/or a generator to divert power to one or more of the driven axles of the vehicle and/or an external circuit.

### BACKGROUND

Hybrid powertrains for vehicles typically comprise an internal combustion engine, such as a diesel or gasoline engine, and one or more motor/generators. Such hybrid vehicles utilize different power sources within different vehicle operating modes, such as an engine-only operating mode, electric-only operating mode, and hybrid operating mode to facilitate drive of the driven axles of the vehicle, as instructed by various control units that execute a variety of control strategies that selectively engage brakes and/or clutches in different combinations and control the engine and electric motor/generator(s). The various modes may be used to improve fuel economy of the vehicle in operation.

### SUMMARY

The present disclosure is directed to a hybrid powertrain with a vehicle-mounted electric motor-generator adapted for use in class three, four, five, six, seven, and eight vehicles as classified by the gross vehicle weight rating (GVWR), i.e., commercial trucks. The present innovation may be provided as an original equipment hybrid powertrain or as an aftermarket or retrofit solution to an existing all-wheel drive hybrid powertrain for such commercial trucks. In each of the original equipment example and the retrofit example, the innovation of the present disclosure may comprise a transfer case assembly configured to control the transfer of power from the vehicle engine and transmission and an onboard electric motor-generator to the respective driven axles, an onboard storage medium such as a battery, or an external payload.

The transfer case assembly may comprise a torque transfer housing defining a transfer case input port, a first transfer case output port, a second transfer case output port, a two-way input/output port disposed opposite the second transfer case output port, and a plurality of axle disconnects.

The transfer case input port is configured to receive a transfer case input member. In such example embodiments the transfer case input member is designed to selectively convey rotational torque or power from the vehicle internal combustion engine and transmission to the transfer case assembly and, as such, the transfer case input member is operatively coupled to a transmission output member.

The first transfer case output port is configured to receive a first transfer case output member. In such example embodiments, the first transfer case output member is designed to selectively convey rotational torque or power from the transfer case assembly to the rear drive shaft to ultimately supply power to the rear driven axle via a rear differential.

The second transfer case output port is configured to receive a second transfer case output member. In such example embodiments, the second transfer case output member is designed to selectively convey rotational torque or power from the transfer case assembly to the front drive shaft to ultimately supply power to the front driven axle via a front differential.

The two-way input/output port is configured to receive a two-way input/output extension member that is disposed in parallel with the first transfer case output member. In such example embodiments, the two-way input/output extension member is selectively couplable to the electric motor-generator and designed to receive rotational torque or power from and/or convey rotational torque of power to the electric motor-generator depending upon the selected operating mode.

The transfer case assembly may further comprise a plurality of axle disconnects configured to selectively couple and decouple the engine with each of the rear drive shaft, the front drive shaft, and the electric motor-generator and to selectively couple and decouple the electric motor-generator with each of the front drive shaft and the rear drive shaft. More particularly, the plurality of axle disconnects further comprise at least a first axle disconnect, a second axle disconnect, and a third axle disconnect. The first axle disconnect being disposed between the first transfer case output member and the rear drive shaft and configured to selectively couple and decouple the first transfer case output member and the rear drive shaft. The second axle disconnect being disposed between the second transfer case output member and the front drive shaft and configured to selectively couple and decouple the second transfer case output member and the front drive shaft. The third axle disconnect being disposed between the two-way input/output extension member and the motor-generator extension shaft and configured to selectively couple and decouple the two-way input/output extension member and motor-generator extension shaft.

The electric motor-generator may be further electrically connected to an onboard energy storage medium via high voltage, direct current (DC) power lines. In this way, the electric motor-generator, when powered by the onboard storage medium, is configured to supply rotational torque to the two-way input/output extension member to transfer torque to the driven axles via the transfer case assembly. Alternatively, the electric motor-generator is further configured to receive torque from the two-way input/output extension member via the motor-generator extension shaft, i.e., rotational torque or power from the engine via an engine crankshaft, the transmission, the transmission output member, the transfer case input member, the torque transfer housing, the two-way input/output extension member, and the motor-generator extension shaft. Such rotational torque or power received from the engine in this way may be transferred to or used to charge the onboard storage medium that is electrically connected to the electric motor-generator.

As such, the original equipment or retrofit powertrain with a vehicle-mounted electric motor-generator of the present disclosure is therefore capable of operating in a variety of plurality of operating modes, namely, a direct power transfer operating mode, a front-wheel-drive auxiliary charge operating mode, a rear-wheel-drive auxiliary charge operating mode, an all-wheel drive auxiliary charge operating mode, a rear-wheel-drive operating mode, an all-wheel drive operating mode, a hybrid rear-wheel-drive operating mode, a hybrid all-wheel drive operating mode, an electric rear-wheel-drive operating mode, and an electric all-wheel drive operating mode.

Notably, in direct power transfer operating mode the vehicle is at idle, with the engine running, such that power or rotational torque from the engine is transferred to the onboard electric motor-generator via the engine crankshaft, the transmission, the transmission output member, the transfer case input member, the torque transfer housing, the two-way input/output extension member, and the motor-generator extension shaft. In this way, the electric motor-generator supplies power to an external payload or charges the onboard storage medium.

Additionally, in each of the front-wheel-drive auxiliary charge operating mode, the rear-wheel-drive auxiliary charge operating mode, and the all-wheel drive auxiliary charge operating mode, the engine powers the driven axle(s), but also provides additional power or rotational torque, in excess of that required to power or drive the driven axles, to the onboard electric motor-generator via the engine crankshaft, the transmission, the transmission output member, the transfer case input member, the torque transfer housing, the two-way input/output extension member, and the motor-generator extension shaft, such that the electric motor-generator may supply power to or charge the onboard storage medium while the vehicle is in motion.

### BRIEF DESCRIPTION OF THE DRAWINGS

The embodiments set forth in the drawings are illustrative and exemplary in nature and not intended to limit the subject matter. The following detailed description of the illustrative embodiments can be understood when read in conjunction with the following drawings, where like structure is indicated with like reference numerals and in which:

FIG. 1 is a schematic side perspective view of an example hybrid powertrain with a vehicle-mounted motor-generator of the present disclosure.

FIG. 2 is a schematic plan view of an example hybrid powertrain with a vehicle-mounted motor-generator of the present disclosure.

FIG. 3A is a schematic, perspective view of an example torque transfer housing of the transfer case assembly of the present disclosure.

FIG. 3B is another schematic, perspective view of an example torque transfer housing of the transfer case assembly of the present disclosure.

FIG. 3C is another schematic, perspective view of an example transfer case assembly of the present disclosure, wherein a first transfer case output member is operatively coupled the rear drive shaft via the first axle disconnect, a second transfer case output member is operatively coupled to the front drive shaft via a second axle disconnect, and a two-way input/output extension member disposed opposite the second transfer case output member and in parallel with the first transfer case output member, which is operatively coupled to the motor-generator via a third axle disconnect.

FIG. 4A is an example vehicle having the hybrid powertrain with a vehicle-mounted motor-generator of the present disclosure, the vehicle being embodied as a mobile charging or refueling vehicle.

FIG. 4B is another example vehicle having the hybrid powertrain with a vehicle-mounted motor-generator of the present disclosure, the vehicle being embodied as a mobile charging or refueling vehicle.

### DETAILED DESCRIPTION

While the present disclosure may be described with respect to specific applications or industries, those skilled in the art will recognize the broader applicability of the disclosure.

The terms “a”, “an”, “the”, “at least one”, and “one or more” are used interchangeably to indicate that at least one of the items is present. A plurality of such items may be present unless the context clearly indicates otherwise. All numerical values of parameters (e.g., of quantities or conditions) in this specification, unless otherwise indicated expressly or clearly in view of the context, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, a disclosure of a range is to be understood as specifically disclosing all values and further divided ranges within the range.

The terms “comprising”, “including”, and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. The term “any of” is understood to include any possible combination of referenced claims of the appended claims, including “any one of” the referenced claims.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting of the claims or the description.

For consistency and convenience, directional adjectives are employed throughout this detailed description corresponding to the illustrated embodiments. Those having ordinary skill in the art will recognize that terms such as “above”, “below”, “upward”, “downward”, “top”, “bottom”, etc., may be used descriptively relative to the figures, without representing limitations on the scope of the invention, as defined by the claims. Any numerical designations, such as “first” or “second” are illustrative only and are not intended to limit the scope of the disclosure in any way.

The term “longitudinal”, as used throughout this detailed description and in the claims, refers to a direction extending a length of a component. The term “forward” or “anterior” is used to refer to the general direction from back to front, and the term “rearward” or “posterior” is used to refer to the opposite direction, from front to back. In some cases, a component may be identified with a longitudinal axis as well as a forward and rearward longitudinal direction along that axis. The longitudinal direction or axis may also be referred to as an anterior-posterior direction or axis.

The term “transverse”, as used throughout this detailed description and in the claims, refers to a direction extending a width of a component. For example, a transverse direction of a component extends between the respective lateral sides of the component and is substantially parallel to the rearward and forward directions.

The term “vertical”, as used throughout this detailed description and in the claims, refers to a direction generally perpendicular to both the lateral and longitudinal directions. The term “upward” or “upwards” refers to the vertical direction pointing towards a top of the component. The term “downward” or “downwards” refers to the vertical direction pointing opposite the upwards direction, toward the bottom of a component. In addition, the term “proximal” refers to a direction that is nearer and the term “distal” refers to a relative position that is further away. Thus, the terms proximal and distal may be understood to provide generally opposing terms to describe relative spatial positions.

In a general sense, the present disclosure provides a hybrid powertrain 10 with a vehicle-mounted electric motor-generator 30 adapted for use in class three, four, five, six, seven, and eight vehicles as classified by the gross vehicle weight rating (GVWR) that may be provided at the original equipment stage or with a retrofit or aftermarket solution with a transfer case assembly 16 configured to control the transfer of power from the vehicle engine 12 and transmission 14 and an on-board electric motor-generator 30 to the respective driven axles 22, 28. The configuration of the transfer case assembly 16 allows the hybrid powertrain 10 to be capable of operating in a variety of operating modes. In one such operating mode, namely, direct power transfer operating mode, the vehicle is at idle with the engine running and may supply power or rotational torque from the engine 12 to the onboard electric motor-generator 30 to power to an external payload or charge an onboard storage medium 32. Additionally, another grouping of operating modes, namely, front-wheel-drive auxiliary charge operating mode, the rear-wheel-drive auxiliary charge operating mode, the all-wheel drive auxiliary charge operating mode, the engine 12 powers the driven axle(s) 22, 28, but also provides additional power or rotational torque, in excess of that required to power or drive the driven axles 22, 28, to the onboard electric motor-generator 30, such that the electric motor-generator 30 may supply power to or charge the onboard storage medium 32 while the vehicle is in motion. In yet another operating mode, neutral operating mode, the engine 12 powers driven axle 28 and the electric motor-generator 30 powers driven axle 22.

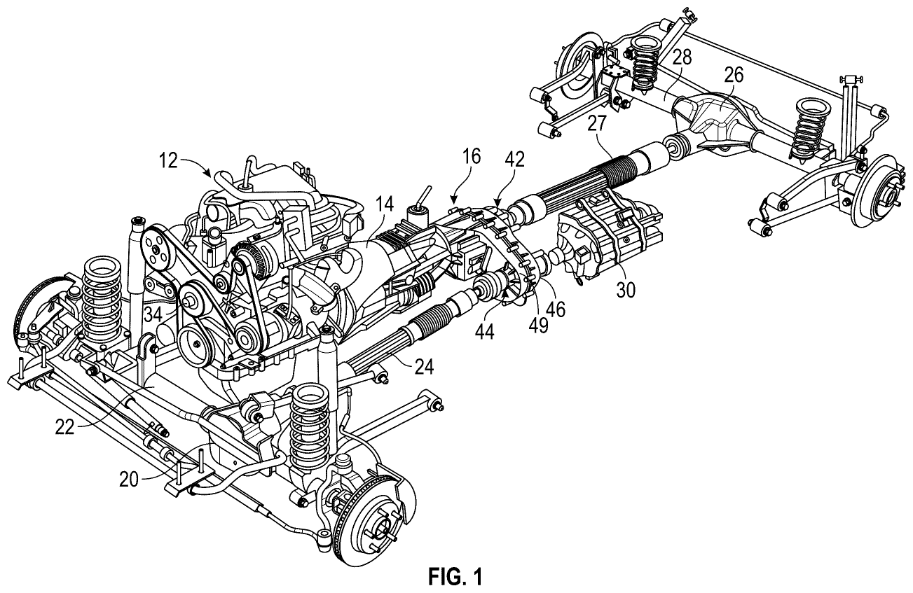

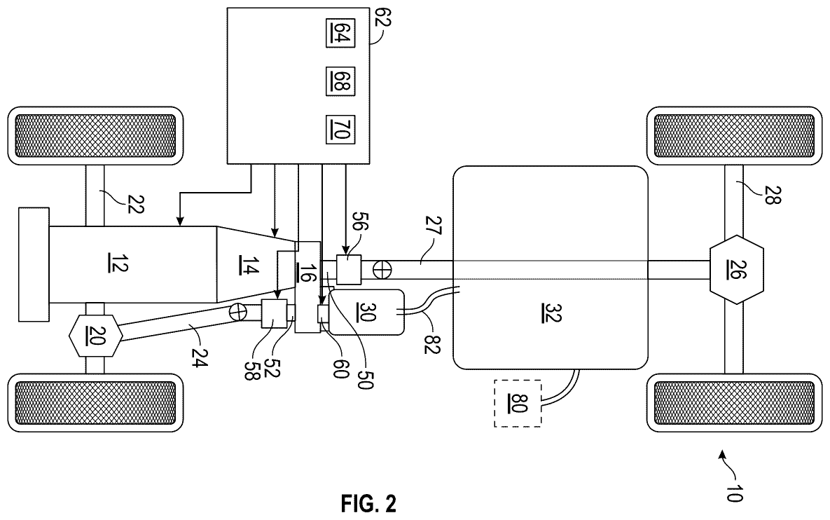

More particularly, referring to FIGS. 1-2, a hybrid powertrain 10 for a vehicle, namely a commercial truck defined in classes three, four, five, six, seven, and eight vehicles as classified by the gross vehicle weight rating (GVWR) is provided. The hybrid powertrain 10 comprises an internal combustion engine 12, a transmission 14, a transfer case assembly 16, an onboard electric motor-generator 30, and an onboard storage medium 32.

The internal combustion engine 12 may be any one of a variety of prime movers including a spark-ignited gasoline or a natural gas fueled engine or a compression ignition diesel engine. It should be apparent to those skilled in the art that other forms of prime movers providing mechanical outputs may be incorporated. The engine 12 may comprise a primary mechanical output or an engine crankshaft 34.

The transmission 14 may be one of a variety of suitable transmissions known in the art, such as a mechanical or automatic geared transmission providing a rotatable transmission input member 36 and a rotatable transmission output member 38. The transmission input member 36 is operatively coupled to the engine crankshaft 34, such that the transmission input member 36 receives rotational torque from the engine 12 via the engine crankshaft 34 and the transmission input member 36.

The powertrain 10 further comprises an onboard electric motor-generator 30. The onboard electric motor-generator 30 is positioned outside of the compartment for the engine 12 or prime mover and the transmission 14. The onboard electric motor-generator 30 may have a horsepower of from about 250 to about 550. In one non-limiting example, the onboard electric motor-generator has a horsepower of 280. The electric motor-generator 30 may further comprise a motor-generator extension shaft 39 or mechanical power input/output.

The electric motor-generator 30 may be further electrically connected to the onboard storage medium 32 via at least one high voltage direct control (DC) power lines or connections 82. The electric onboard storage medium 32 may comprise an onboard battery having at least fifty (50) kWhr of electrical power, and more particularly, from about fifty (50) kWhr to about one (1) MWhr of electrical power. Alternatively, the onboard storage medium 32 may comprise a plurality of fuel cells.

As in any traditional vehicle or automobile having an all-wheel drive configuration, the hybrid powertrain 10 further includes a front axle 22 coupled to and in fluid communication with a front drive shaft 24 via a front differential 20 as well as a rear driven axle 28 coupled to and in fluid communication with a rear drive shaft 27 via a rear differential 26.

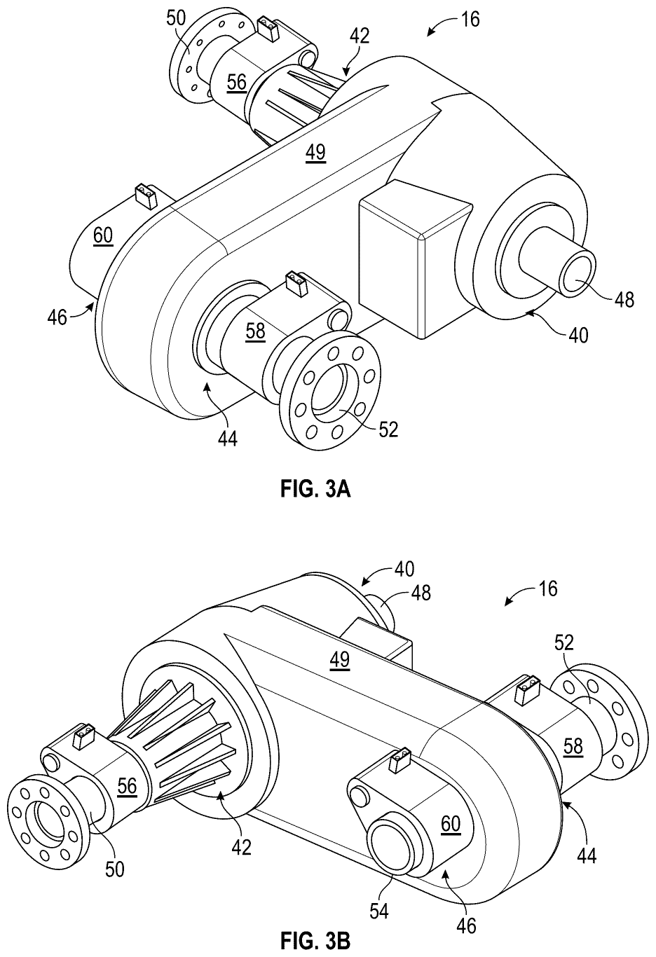

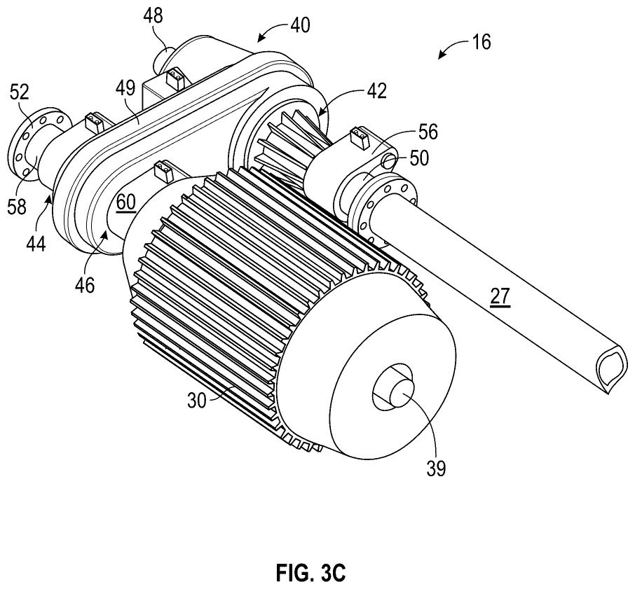

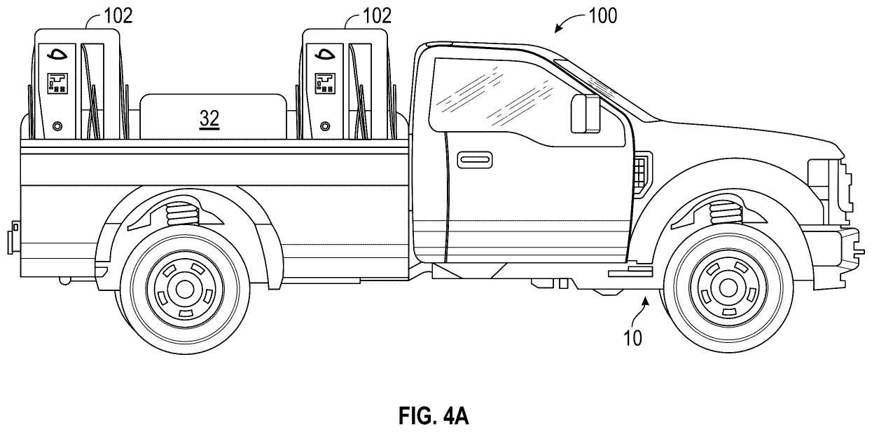

The transfer of rotational torque or power from the engine 12 and transmission 14 respectively to the respective driven axle(s) and the electric motor-generator is facilitated via a transfer case assembly 16. As shown in greater detail in FIGS. 3A-3C, the transfer case assembly 16 comprises a torque transfer housing 49 that defines a plurality of input and output ports 40, 42, 44, 46 and further comprises a plurality of rotatable input and output members 48, 50, 52, 54. The plurality of input and output ports 40, 42, 44, 46 (FIGS. 3A-3B) are configured to receive the plurality of rotatable input and output members 48, 50, 52, 54 (FIG. 3C). The transfer case assembly 16 further comprises a plurality of axle disconnects 56, 58, 60 configured to selectively couple and decouple the engine 12 and transmission 14 with each of the rear drive shaft 27, the front drive shaft 24, and the electric motor-generator 30 and further configured to selectively couple and decouple the electric motor-generator 30 with each of the front drive shaft 24 and the rear drive shaft 27.

Referring to FIGS. 3A-3C, the transfer case assembly 16 comprises a torque transfer housing 49. The torque transfer housing 49 defines a transfer case input port 40, a first transfer case output port 42, a second transfer case output port 44, and a two-way input/output port 46. The two-way input/output port 46 is disposed opposite the second transfer case output port 44.

The transfer case input port 40 is configured to receive a transfer case input member 48. The transfer case input member 48 is operatively coupled to the transmission output member 38. In such example embodiments, the transfer case input member 48 is configured to selectively convey rotational torque or power from the engine 12 and transmission 14 to the transfer case assembly 16 for further transfer to other components of the vehicle powertrain 10, namely the front driven axle 22 via the front drive shaft 24 and the front differential 20, the rear driven axle 28 via the rear drive shaft 27 and the rear differential 26, and the electric motor-generator 30.

The first transfer case output port 42 is configured to receive a first transfer case output member 50. The first transfer case output member 50 is operatively coupled to the rear drive shaft 27. In such example embodiments, the first transfer case output member 50 is designed to selectively convey rotational torque or power from the transfer case assembly 16 to the rear drive shaft 27 and ultimately the rear driven axle 28 via the rear differential 26.

The second transfer case output port 44 is configured to receive a second transfer case output member 52. The second transfer case output member 52 is operatively coupled to the front drive shaft 24. In such example embodiments, the second transfer case output member 52 is designed to selectively convey rotational torque or power from the transfer case assembly 16 to the front drive shaft 24 to ultimately supply power to the front driven axle 22 via a front differential 20.

The two-way input/output port 46 is configured to receive a two-way input/output extension member 54. In this way, and due to the positioning of the first transfer case output port 42 and the two-way input/output port 46, the two-way input/output extension member 54 is disposed in parallel with the first transfer case output member 42. Additionally, the two-way input/output extension member 54 is operatively coupled to the electric motor-generator extension shaft 39. In such example embodiments, the two-way input/output extension member 46 is selectively couplable to the electric motor-generator 30 and designed to receive rotational torque or power from and/or convey rotational torque or power to the electric motor-generator 30. Notably, the electric motor-generator 30 is configured to supply rotational torque to the two-way input/output extension member 54 and receive torque from the two-way input/output extension member 54 via the motor-generator extension shaft 39.

In this way, the electric motor-generator 30, when powered by the onboard storage medium 32, is configured to supply rotational torque to the two-way input/output extension member 54 to transfer torque to the driven axles 22, 28 via the transfer case assembly 16. Alternatively, the electric motor-generator 30 is further configured to receive torque from the two-way input/output extension member 54 via the motor-generator extension shaft 39, i.e., rotational torque or power from the engine 12 via an engine crankshaft 34, the transmission input member 36, the transmission 14, the transmission output member 38, the transfer case input member 40, the torque transfer housing 49, the two-way input/output extension member 54, and the motor-generator extension shaft 39. Such rotational torque or power received from the engine 12 in this way may be transferred to or used to charge the onboard storage medium 32 that is electrically connected to the electric motor-generator 30.

The transfer case assembly 16 may further comprise a plurality of axle disconnects 56, 58, 60 configured to selectively couple and decouple the engine 12 and transmission 14 with each of the rear drive shaft 27, the front drive shaft 24, and the electric motor-generator 30 and further configured to selectively couple and decouple the electric motor-generator 30 with each of the front drive shaft 24 and the rear drive shaft 27. More particularly, the plurality of axle disconnects further comprise at least a first axle disconnect 56, a second axle disconnect 58, and a third axle disconnect 60.

The first axle disconnect 56 may be embodied as a mechanical clutch such as a friction clutch or the like. Alternatively, the first axle disconnect 56 may be embodied as an electromagnetic tooth clutch with a slip ring. The first axle disconnect 56 is disposed between the first transfer case output member 50 and the rear drive shaft 27 and is configured to selectively couple and decouple the first transfer case output member 50 and the rear drive shaft 27.

The second axle disconnect 58 may be embodied as a mechanical clutch such as a friction clutch or the like. Alternatively, the second axle disconnect 58 may be embodied as an electromagnetic tooth clutch with a slip ring. The second axle disconnect 58 is disposed between the second transfer case output member 52 and the front drive shaft 24 and is configured to selectively couple and decouple the second transfer case output member 52 and the front drive shaft 24.

The third axle disconnect 60 may be embodied as a mechanical clutch such as a friction clutch or the like. Alternatively, the third axle disconnect 60 may be embodied as an electromagnetic tooth clutch with a slip ring. The third axle disconnect 60 is disposed between the two-way input/output extension member 54 and the motor-generator extension shaft 39 and configured to selectively couple and decouple the two-way input/output extension member 54 and motor-generator extension shaft 39.

The powertrain 10 may be connected to at least one control unit 62. The control unit 62 may be a single control unit in fluid electrical communication with the engine 12, the transmission 14, the electric motor-generator 30, the onboard storage medium 32, the plurality of axle disconnects 56, 58, 60 and other system components. In such an example, the control unit 62 would be integrated or a component part of a traditional powertrain control module. The at least one control unit 62 may also be embodied as a plurality of control units designed to control a specific system component, for example, an engine control unit or ECU in fluid electrical communication with the engine 12, a transmission control unit TCU in fluid electrical communication with the transmission, and the like. In such an example, the plurality of control units 62 would be supplemental to a traditional powertrain control module.

The control unit 62 may include a non-transitory computer readable medium or a memory 64 and a processor 68 configured to execute the computer executable instructions 70 embodied in the computer readable medium 64. The computer executable instructions 70 may take the form of an algorithm or other control strategy written on the computer readable medium 64. Such a computer readable medium or memory 64 may take many forms, including, but not limited to, non-volatile media, volatile media, etc. Non-volatile media include, for example, optical or magnetic disks and other persistent memory. Volatile media include dynamic random-access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read, as well as networked versions of the same.

The computer readable medium 64 may also house databases or data stores that may include various kinds of mechanisms for storing, accessing, and retrieving various kinds of data, including a hierarchical database, a set of files in a file system, an application database in a proprietary format, a relational database management system (RDBMS), a non-relational database management system, a look-up table, etc. that may be referenced by the processor 68 during the execution of the computer executable instructions 70.

As detailed herein, the at least one a processor 68 is configured to execute the computer executable instructions 70 embodied in the memory 64 of the control unit 62, such that the memory 64 is configured to instruct the processor 68 to send signals to one of more of the engine 12, the transmission 14, the electric motor-generator 30, the plurality of axle disconnects 56, 58, 60 and the onboard storage medium 32 to control a power flow of the powertrain 10 in a plurality of operating modes, namely, a direct power transfer operating mode, a front-wheel-drive auxiliary charge operating mode, a rear-wheel-drive auxiliary charge operating mode, an all-wheel drive auxiliary charge operating mode, a rear-wheel-drive operating mode, an all-wheel drive operating mode, a hybrid rear-wheel-drive operating mode, a hybrid all-wheel drive operating mode, an electric rear-wheel-drive operating mode, an electric all-wheel drive operating mode, and a neutral operating mode.

In each operating mode, among other control functions, the control unit 62 sends a signal to each of the respective axle disconnects 56, 58, 60 in order to create the desired power flow through the powertrain system 10 by selectively coupling and decoupling the engine 12 with each of the rear drive shaft 27, the front drive shaft 24, and the electric motor-generator extension shaft 39 and to selectively couple and decouple the electric motor-generator 30 with each of the front drive shaft 24 and the rear drive shaft 27.

In the direct power transfer operating mode the control unit 62 simultaneously sends a first signal to the first axle disconnect 56 to selectively decouple the first transfer case output member 50 and the rear drive shaft 27, a second signal to the second axle disconnect 58 to selectively decouple the second transfer case output member 52 and the front drive shaft 24, and a third signal to the third axle disconnect 60 to selectively couple the two-way input/output extension member 54 and the motor-generator extension shaft 39. In this way, the electric motor-generator 32 is configured to receive rotational torque from the engine 12 via the engine crankshaft 34, the transmission 14, the transmission output member 38, the transfer case input member 48, the torque transfer housing 49, the two-way input/output extension member 54, and the motor-generator extension shaft 39.

Notably, in direct power transfer operating mode the vehicle 100 is at idle, with the engine running and emergency brakes applied, such that all power or rotational torque from the engine 12, not used to power cab electronics and other vehicle systems, is transferred to the onboard electric motor-generator 30 via the engine crankshaft 34, the transmission 14, the transmission output member 38, the transfer case input member 48, the torque transfer housing 49, the two-way input/output extension member 54, and the motor-generator extension shaft 39. In this way, the electric motor-generator 62 may supply power to charge the onboard storage medium 32. Alternatively, the electric motor-generator 62 may transfer power from the engine 12 into electrical energy via the onboard storage medium 32 that may be used to power an external payload 80.

Additionally, in each of the front-wheel-drive auxiliary charge operating mode, the rear-wheel-drive auxiliary charge operating mode, the all-wheel drive auxiliary charge operating mode, the engine 12 powers the driven axle(s) 22, 28, but also provides additional power or rotational torque, in excess of that required to power the vehicle 100 or drive the driven axles 22, 28, to the onboard electric motor-generator 30 via the engine crankshaft 34, the transmission 14, the transmission output member 38, the transfer case input member 48, the torque transfer housing 49, the two-way input/output extension member 54, and the motor-generator extension shaft 39, such that the electric motor-generator 30 may supply power to or charge the onboard storage medium 32 while the vehicle 100 is in motion. Such additional power or rotational torque from the engine 12 may come in the form of regenerative braking energy transferred to the electric motor-generator 30 or by running the engine 12 at a power level (horsepower) in excess of what is need to power the vehicle 100 in a particular state, in each case the additional power or rotational torque supplied by the engine 12 in excess of what is required to power the vehicle 100 via the driven axle(s) 22, 28 is directed to the electric motor-generator 30 via the engine crankshaft 34, the transmission 14, the transmission output member 38, the transfer case input member 48, the torque transfer housing 49, the two-way input/output extension member 54, and the motor-generator extension shaft 39 to charge the onboard storage medium 32.

More particularly, in rear-wheel-drive auxiliary charge operating mode the control unit 62 simultaneously sends a first signal to the first axle disconnect 56 to selectively couple the first transfer case output member 52 and the rear drive shaft 27, a second signal to the second axle disconnect 58 to selectively decouple the second transfer case output member 52 and the front drive shaft 24, and a third signal to the third axle disconnect 60 to selectively couple the two-way input/output extension member 54 and the motor-generator extension shaft 39. In this way, power flow comes from only one prime mover, namely the engine 12 configured to provide power to the rear drive shaft 27 to propel or drive the rear driven axle 28 and power the vehicle 100. Said another way, the rear driven axle 28 is configured to drive the vehicle via rotational torque received from the engine 12 via the engine crankshaft 34, the transmission 14, the transmission output member 38, the transfer case input member 48, the torque transfer housing 49, the first transfer case output member 50, the rear drive shaft 27, and the rear differential 26.

In the front-wheel-drive auxiliary charge operating mode the control unit 62 simultaneously sends a first signal to the first axle disconnect 56 to selectively decouple the first transfer case output member 52 and the rear drive shaft 27, a second signal to the second axle disconnect 58 to selectively couple the second transfer case output member 52 and the front drive shaft 24, and a third signal to the third axle disconnect 60 to selectively couple the two-way input/output extension member 54 and the motor-generator extension shaft 39. In this way, power flow comes from only one prime mover, namely the engine 12 configured to provide power to the front drive shaft 24 to propel or drive the front driven axle 22 and power the vehicle 100. Said another way, the front axle 22 is configured to drive the vehicle 100 via rotational torque received from the engine 12 via the engine crankshaft 34, the transmission 14, the transmission output member 38, the transfer case input member 48, the torque transfer housing 49, the second transfer case output member 52, the front drive shaft 24, and the front differential 20.

Finally, in the all-wheel drive auxiliary charge operating mode the control unit 62 simultaneously sends a first signal to the first axle disconnect 56 to selectively couple the first transfer case output member 52 and the rear drive shaft 27, a second signal to the second axle disconnect 58 to selectively couple the second transfer case output member 52 and the front drive shaft 24, and a third signal to the third axle disconnect 60 to selectively couple the two-way input/output extension member 54 and the motor-generator extension shaft 39. In this way, power flow comes from only one prime mover, namely the engine 12 configured to provide power to each of the front drive shaft 24 to propel or drive the front driven axle 22 and the rear drive shaft 27 to propel or drive the rear driven axle 28 and power the vehicle 100. Said another way, the driven front and rear axles 22, 28 are collectively configured to drive the vehicle 100, wherein the front driven axle 22 receives rotational torque received from the engine 12 via the engine crankshaft 34, the transmission 14, the transmission output member 38, the transfer case input member 48, the torque transfer housing 49, the second transfer case output member 52, the front drive shaft 24, and the front differential 20 and the rear driven axle 28 receives rotational torque received from the engine 12 via the engine crankshaft 34, the transmission 14, the transmission output member 38, the transfer case input member 48, the torque transfer housing 49, the first transfer case output member 50, the rear drive shaft 27, and the rear differential 26.

However, in each of the rear-wheel drive, front-wheel drive and all-wheel drive auxiliary charge operating modes the vehicle may only require a first horsepower to drive the vehicle 100. As such, the control unit 62 may instruct the engine 12 to operate at a second horsepower greater than the first horsepower or the vehicle 100 may undergo a braking event, such that the kinetic energy of the vehicle (second horsepower) that is in excess of what is required to power the vehicle (first horsepower) may be regenerated or recovered and transferred to the electric motor-generator 30. The excess or additional horsepower instructed by the control unit 62 to be provided by the engine 12 or captured during regenerative braking event may be defined as the positive difference between the second horsepower and the first horsepower. This positive net difference in power may be transferred to the electric motor-generator 30, which, in such a power flow operates exclusively as a generator, rather than the driven axle(s). In this way, the electric motor-generator 30 is configured to receive rotational torque from the engine 12, in the amount of positive difference between the second horsepower and the first horsepower, via the engine crankshaft 34, the transmission 14, the transmission output member 38, the transfer case input member 48, the torque transfer housing 49, the two-way input/output extension member 54 and the motor-generator extension shaft 39. The electric motor-generator 30 is then further configured to utilize such power to charge the onboard storage medium 32 while the vehicle 100 is in motion.

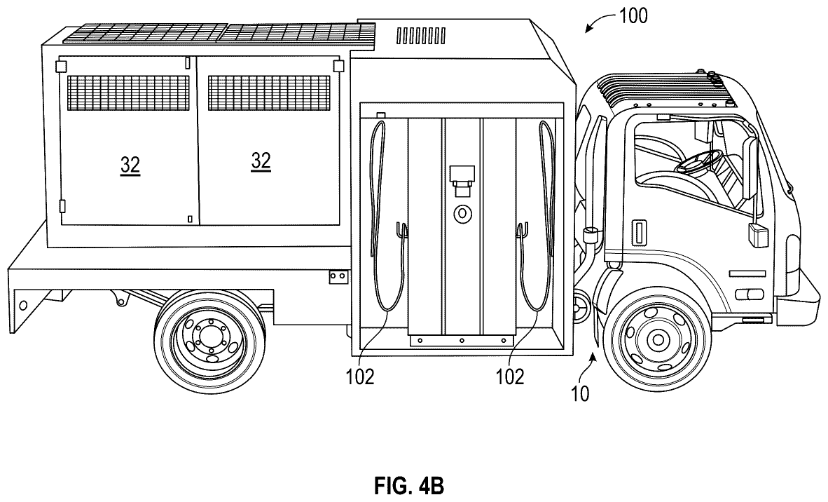

Due to the ability of the vehicle 100 to create and sustain a charge in the onboard storage medium 32, particularly in the direct power transfer operating mode, the rear-wheel drive operating mode, front-wheel drive operating mode and all-wheel drive auxiliary charge operating mode, the vehicle 100 may be uniquely equipped and useful as a mobile, deployable, on-demand power source as shown in FIGS. 4A and 4B. In one example embodiment, as shown in FIGS. 4A-4B the vehicle may be embodied as a mobile, deployable recharge vehicle capable of recharging one or more electric vehicles via DC fast charge applications 102 or operating one or more external electric circuits via the engine 12 and the electric motor-generator 30 as an external payload 80 in direct power transfer operating mode or via the charged onboard storage medium 32.

In addition to the aforementioned modes of operation, the powertrain 10 may also operate in more traditional hybrid-electric or fully electric drive modes in which no additional power or energy from the engine 12 is channeled to the electric motor-generator 30, namely, hybrid rear-wheel drive operating mode, hybrid all-wheel drive operating mode, and pure electric rear-wheel-drive operating mode, pure electric all-wheel drive operating mode, and neutral operating mode.

In the hybrid rear-wheel-drive operating mode, the control unit 62 simultaneously sends a first signal to the first axle disconnect 56 to selectively couple the first transfer case output member 50 and the rear drive shaft 27, a second signal to the second axle disconnect 58 to selectively decouple the second transfer case output member 52 and the front drive shaft 24, and a third signal to the third axle disconnect 60 to selectively couple the two-way input/output extension member 54 and the motor-generator extension shaft 39. In this way power flow throughout the powertrain 10 comes from two movers or power sources, i.e., the engine 12 and the electric motor-generator 30, each configured to provide power to drive the rear driven axle 28. In this way, the first power flow directs rotational torque or power from the engine 12 to the rear drive shaft 27 to propel or drive the rear driven axle 28 and power the vehicle 100. Said another way, the rear driven axle 28 is configured to drive the vehicle via rotational torque received from the engine 12 via the engine crankshaft 34, the transmission 14, the transmission output member 38, the transfer case input member 48, the torque transfer housing 49, the first transfer case output member 50, the rear drive shaft 27, and the rear differential 26. The second power flow directs rotational torque or power from the electric motor-generator 30 to the rear drive shaft 27 to propel or drive the rear driven axle 28 and power the vehicle 100. Said another way, the rear driven axle 28 is configured to drive the vehicle 100 via rotational torque received from the electric motor-generator 30 via the motor-generator extension shaft 39, the two-way input/output extension member 54, the torque transfer housing 49, the first transfer case output member 48, the rear drive shaft 27, and the rear differential 26.

In the hybrid all-wheel drive operating mode, the control unit 62 simultaneously sends a first signal to the first axle disconnect 56 to selectively couple the first transfer case output member 50 and the rear drive shaft 27, a second signal to the second axle disconnect 58 to selectively couple the second transfer case output member 52 and the front drive shaft 24, and a third signal to the third axle disconnect 60 to selectively couple the two-way input/output extension member 54 and the motor-generator extension shaft 39. In this way power flow throughout the powertrain comes from two movers or power sources, i.e., the engine 12 and the electric motor-generator 30 each configured to provide power to drive the driven axles, namely the front driven axle 22 and the rear driven axle 28. In this way, the first power flow directs rotational torque or power from the engine 12 to the front drive shaft 24 to propel or drive the driven front axle 22 and to the rear drive shaft 27 to propel or drive the rear driven axle 28 and power the vehicle 100. Said another way, the rear driven axle 28 is configured to drive the vehicle via rotational torque received from the engine 12 via the engine crankshaft 34, the transmission 14, the transmission output member 38, the transfer case input member 48, the torque transfer housing 49, the first transfer case output member 50, the rear drive shaft 27, and the rear differential 26 and the front axle 22 is configured to drive the vehicle via rotational torque received from the engine 12 via the engine crankshaft 34, the transmission 14, the transmission output member 38, the transfer case input member 48, the torque transfer housing 49, the second transfer case output member 52, the front drive shaft 24, and the front differential 20.

In the second power flow, rotational torque or power from the electric motor-generator 30 to the front drive shaft 24 to propel or drive the driven front axle 22 and to the rear drive shaft 27 to propel or drive the rear driven axle 28 and power the vehicle 100. Said another way, the rear driven axle 28 is configured to drive the vehicle via rotational torque received from the electric motor-generator 30 via the motor-generator extension shaft 39, the two-way input/output extension member 54, the torque transfer housing 49, the first transfer case output member 48, the rear drive shaft 27, and the rear differential 26 and the front axle 22 is configured to drive the vehicle via rotational torque received from the electric motor-generator 30 via the motor-generator extension shaft 39, the two-way input/output extension member 54, the torque transfer housing 49, the second transfer case output member 52, the front drive shaft 24, and the front differential 20.

In the pure electric rear-wheel-drive operating mode, the control unit 62 simultaneously sends a first signal to the first axle disconnect 56 to selectively couple the first transfer case output member 50 and the rear drive shaft 27, a second signal to the second axle disconnect 58 to selectively decouple the second transfer case output member 52 and the front drive shaft 24, and a third signal to the third axle disconnect 60 to selectively couple the two-way input/output extension member 54 and the motor-generator extension shaft 39, and a fourth signal to the transmission 14 to selectively decouple the transmission output member 38 and the transfer case input member 48. In this way, power flow throughout the powertrain comes from only a single mover or power source, i.e., the electric motor-generator 30 that is configured to provide power to drive the rear driven axle 28. In this way, the power flow directs rotational torque or power from the electric motor-generator 30 to the rear drive shaft 27 to propel or drive the rear driven axle 28 and power the vehicle 100. Said another way, the rear driven axle 28 is configured to drive the vehicle 100 via rotational torque received from the electric motor-generator 30 via the motor-generator extension shaft 39, the two-way input/output extension member 54, the torque transfer housing 49, the first transfer case output member 48, the rear drive shaft 27, and the rear differential 26.

In the pure electric all-wheel drive operating mode, the control unit 62 simultaneously sends a first signal to the first axle disconnect 56 to selectively couple the first transfer case output member 50 and the rear drive shaft 27, a second signal to the second axle disconnect 58 to selectively couple the second transfer case output member 52 and the front drive shaft 24, and a third signal to the third axle disconnect 60 to selectively couple the two-way input/output extension member 54 and the motor-generator extension shaft 39, and a fourth signal to the transmission 14 to selectively decouple the transmission output member 38 and the transfer case input member 48. In this way, power flow throughout the powertrain comes from only a single mover or power source, i.e., the electric motor-generator 30 that is configured to provide power to drive the driven axles, namely the front driven axle 22 and the rear driven axle 28. In this way, the power flow directs rotational torque or power from the electric motor-generator 30 to the front drive shaft 24 to propel or drive the driven front axle 22 and to the rear drive shaft 27 to propel or drive the rear driven axle 28 and power the vehicle 100. Said another way, the rear driven axle 28 is configured to drive the vehicle via rotational torque received from the electric motor-generator 30 via the motor-generator extension shaft 39, the two-way input/output extension member 54, the torque transfer housing 49, the first transfer case output member 48, the rear drive shaft 27, and the rear differential 26 and the front axle 22 is configured to drive the vehicle via rotational torque received from the electric motor-generator 30 via the motor-generator extension shaft 39, the two-way input/output extension member 54, the torque transfer housing 49, the second transfer case output member 52, the front drive shaft 24, and the front differential 20.

In engine only rear-wheel-drive operating mode, the control unit 62 simultaneously sends a first signal to the first axle disconnect 56 to selectively couple the first transfer case output member 50 and the rear drive shaft 27, a second signal to the second axle disconnect 58 to selectively decouple the second transfer case output member 52 and the front drive shaft 24, and a third signal to the third axle disconnect 60 to selectively decouple the two-way input/output extension member 54 and the motor-generator extension shaft 39. In this way power flow throughout the powertrain comes from only the prime mover or power source, i.e., the engine 12 that is configured to provide power to drive the rear driven axle 28. In this way, the power flow directs rotational torque or power from the engine 12 to the rear drive shaft 27 to propel or drive the rear driven axle 28 and power the vehicle 100. Said another way, the rear driven axle 28 is configured to drive the vehicle via rotational torque received from the engine 12 via the engine crankshaft 34, the transmission 14, the transmission output member 38, the transfer case input member 48, the torque transfer housing 49, the first transfer case output member 50, the rear drive shaft 27, and the rear differential 26. In such an instance the decoupling of the two-way input/output extension member 54 and the motor-generator extension shaft 39 by the third axle disconnect 60 indicates that no power is transferred from or to the electric motor-generator 30.

In the engine only all-wheel drive operating mode, the control unit 62 simultaneously sends a first signal to the first axle disconnect 56 to selectively couple the first transfer case output member 50 and the rear drive shaft 27, a second signal to the second axle disconnect 58 to selectively couple the second transfer case output member 52 and the front drive shaft 24, and a third signal to the third axle disconnect 60 to selectively decouple the two-way input/output extension member 54 and the motor-generator extension shaft 39. In this way power flow throughout the powertrain comes from a single mover or power source, i.e., the engine 12 configured to provide power to drive the driven axles, namely the front driven axle 22 and the rear driven axle 28. Said another way, the rear driven axle 28 is configured to drive the vehicle via rotational torque received from the engine 12 via the engine crankshaft 34, the transmission 14, the transmission output member 38, the transfer case input member 48, the torque transfer housing 49, the first transfer case output member 50, the rear drive shaft 27, and the rear differential 26. The front axle 22 is configured to drive the vehicle via rotational torque received from the engine 12 via the engine crankshaft 34, the transmission 14, the transmission output member 38, the transfer case input member 48, the torque transfer housing 49, the second transfer case output member 52, the front drive shaft 24, and the front differential 20. In such an instance the decoupling of the two-way input/output extension member 54 and the motor-generator extension shaft 39 by the third axle disconnect 60 indicates that no power is transferred from or to the electric motor-generator 30.

In the neutral operating mode, the control unit 62 simultaneously sends a first signal to the first axle disconnect 56 to selectively couple the first transfer case output member 50 and the rear drive shaft 27, a second signal to the second axle disconnect 58 to selectively couple the second transfer case output member 52 and the front drive shaft 24, and a third signal to the third axle disconnect 60 to selectively couple the two-way input/output extension member 54 and the motor-generator extension shaft 39, and a fourth signal to place the transfer case assembly 16 into neutral.

In this way power flow throughout the powertrain comes from two movers or power sources, i.e., the engine 12 and the electric motor-generator 30 each configured to provide power or drive a respective driven axle 22, 28. In this way, the first power flow directs rotational torque or power from the engine 12 to the rear drive shaft 27 to propel or drive the driven rear axle 28. Said another way, the rear driven axle 28 is configured to drive the vehicle via rotational torque received from the engine 12 via the engine crankshaft 34, the transmission 14, the transmission output member 38, the transfer case input member 48, the torque transfer housing 49, the first transfer case output member 50, the rear drive shaft 27, and the rear differential 26. The second power flow directs rotational torque or power from the electric motor-generator 30 to the front drive shaft 24 to propel or drive the front driven axle 22. Said another way, the front axle 22 is configured to drive the vehicle 100 via rotational torque received from the electric motor-generator 30 via the motor-generator extension shaft 39, the two-way input/output extension member 54, the torque transfer housing 49, the second transfer case output member 52, the front drive shaft 24, and the front differential 20.

In the neutral operating mode, the front driven axle 22 and rear driven axle 28 receive power from two independent sources, such that power may be delivered to the respective drive axles 22, 28 at different speeds, different torques, or even in opposite rotational directions.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims.

Benefits, other advantages, and solutions to problems, and any element or elements that may cause any benefit, advantage, or solution to occur or become more pronounced, however, are not to be construed as critical, required, or essential features or elements of any or all of the claims, unless such benefits, advantages, solutions, or elements are expressly stated in such claims.

What is claimed is:

1. A powertrain for a vehicle having a front axle and a rear axle, the powertrain comprising:
an onboard storage medium;
an internal combustion engine having an engine crankshaft;
a rear drive shaft in fluid communication with the rear axle via a rear differential;
a front drive shaft in fluid communication with the front axle via a front differential;
a transmission having a transmission output member and a transmission input member that is operatively coupled to the engine crankshaft;
a transfer case assembly having:
a torque transfer housing having a transfer case input port, a first transfer case output port, a second transfer case output port, and a two-way input/output port disposed opposite the second transfer case output port;
a transfer case input member operatively coupled to the transmission output member and configured to be received by the torque transfer housing at the transfer case input port;
a first transfer case output member operatively coupled the rear drive shaft and configured to be received by the torque transfer housing at the first transfer case output port;
a second transfer case output member operatively coupled to the front drive shaft and configured to be received by the torque transfer housing at the second transfer case output port; and
a two-way input/output extension member configured to be received by the torque transfer housing at two-way input/output port, such that the two-way input/output extension member is disposed in parallel with the first transfer case output member; and
at least one electric motor-generator having a motor-generator extension shaft operatively coupled to the two-way input/output member, the electric motor-generator being further electrically connected to the onboard storage medium, wherein the electric motor-generator is defined as an onboard battery having from about fifty (50) kWhr to about one (1) MWhr of electrical power configured to supply rotational torque to the two-way input/output extension member and receive torque from the two-way input/output extension member via the motor-generator extension shaft.

2. The powertrain of claim 1 further comprising a plurality of axle disconnects configured to selectively couple and decouple the engine with each of the rear drive shaft, the front drive shaft, and the electric motor-generator and further configured to selectively couple and decouple the electric motor-generator with each of the front drive shaft and the rear drive shaft, the plurality of axle disconnect further comprising:
a first axle disconnect disposed between the first transfer case output member and the rear drive shaft, the first axle disconnect configured to selectively couple and decouple the first transfer case output member and the rear drive shaft;
a second axle disconnect disposed between the second transfer case output member and the front drive shaft, the second axle disconnect configured to selectively couple and decouple the second transfer case output member and the front drive shaft; and
a third axle disconnect disposed between the two-way input/output extension member and the motor-generator extension shaft, the third axle disconnect configured to selectively couple and decouple the two-way input/output extension member and motor-generator extension shaft.

3. The powertrain of claim 2 further comprising a control unit in fluid communication with the engine, the electric motor-generator, the plurality of axle disconnects, and the onboard storage medium, the control unit having a non-transitory computer readable medium that stores a set of computer executable instructions and at least one processor configured to execute the computer executable instructions embodied on the non-transitory computer readable medium, wherein the computer executable instructions cause the control unit and the processor to send signals to one of the engine, the electric motor-generator, the plurality of axle disconnects, and the onboard storage medium to control a power flow of the powertrain in a plurality of operating modes.

4. The powertrain of claim 3 wherein the plurality of operating modes comprises a direct power transfer operating mode, wherein in the direct power transfer operating mode the control unit simultaneously sends a first signal to the first axle disconnect to selectively decouple the first transfer case output member and the rear drive shaft, a second signal to the second axle disconnect to selectively decouple the second transfer case output member and the front drive shaft, and a third signal to the third axle disconnect to selectively couple the two-way input/output extension member and the motor-generator extension shaft; and
wherein the electric motor-generator is configured to receive rotational torque from the engine via the engine crankshaft, the transmission, the transmission output member, the transfer case input member, the torque transfer housing, the two-way input/output extension member, and the motor-generator extension shaft.

5. The powertrain of claim 4 wherein the electric motor-generator is further configured to supply power to the onboard storage medium.

6. The powertrain of claim 4 wherein the electric motor-generator is further configured to supply power to an external payload.

7. The powertrain of claim 3 wherein the plurality of operating modes comprises a front-wheel-drive auxiliary charge operating mode, wherein in the front-wheel-drive auxiliary charge operating mode the control unit simultaneously sends a first signal to the first axle disconnect to selectively decouple the first transfer case output member and the rear drive shaft, a second signal to the second axle disconnect to selectively couple the second transfer case output member and the front drive shaft, and a third signal to the third axle disconnect to selectively couple the two-way input/output extension member and the motor-generator extension shaft;
wherein the front axle is configured to drive the vehicle via rotational torque received from the engine via the engine crankshaft, the transmission, the transmission output member, the transfer case input member, the torque transfer housing, the second transfer case output member, the front drive shaft, and the front differential;
wherein electric motor-generator is configured to receive rotational torque from the engine via the engine crankshaft, the transmission, the transmission output member, the transfer case input member, the torque transfer housing, the two-way input/output extension member, and the motor-generator extension shaft; and
wherein the electric motor-generator is further configured to supply power to the onboard storage medium.

8. The powertrain of claim 3 wherein the plurality of operating modes comprises a rear-wheel-drive auxiliary charge operating mode, wherein in the rear-wheel-drive auxiliary charge operating mode the control unit simultaneously sends a first signal to the first axle disconnect to selectively couple the first transfer case output member and the rear drive shaft, a second signal to the second axle disconnect to selectively decouple the second transfer case output member and the front drive shaft, and a third signal to the third axle disconnect to selectively couple the two-way input/output extension member and the motor-generator extension shaft; and
wherein the rear axle is configured to drive the vehicle via rotational torque received from the engine via the engine crankshaft, the transmission, the transmission output member, the transfer case input member, the torque transfer housing, the first transfer case output member, the rear drive shaft, and the rear differential;
wherein electric motor-generator is configured to receive rotational torque from the engine via the engine crankshaft, the transmission, the transmission output member, the transfer case input member, the torque transfer housing, the two-way input/output extension member and the motor-generator extension shaft; and
wherein the electric motor-generator is further configured to supply power to the onboard storage medium.

9. The powertrain of claim 3 wherein the plurality of operating modes comprises an all-wheel drive auxiliary charge operating mode, wherein in the all-wheel drive auxiliary charge operating mode the control unit simultaneously sends a first signal to the first axle disconnect to selectively couple the first transfer case output member and the rear drive shaft, a second signal to the second axle disconnect to selectively couple the second transfer case output member and the front drive shaft, and a third signal to the third axle disconnect to selectively couple the two-way input/output extension member and the motor-generator extension shaft; and
wherein the front axle and rear axle are collectively configured to drive the vehicle, such that the rear axle is driven via rotational torque received from the engine via the engine crankshaft, the transmission, the transmission output member, the transfer case input member, the torque transfer housing, the first transfer case output member, the rear drive shaft and the rear differential and the front axle is driven via rotational torque received from the engine via the engine crankshaft, the transmission, the transmission output member, the transfer case input member, the torque transfer housing, the second transfer case output member, the front drive shaft, and the front differential;
wherein electric motor-generator is configured to receive rotational torque from the engine via the engine crankshaft, the transmission, the transmission output member, the transfer case input member, the torque transfer housing, the two-way input/output extension member and the motor-generator extension shaft; and
wherein the electric motor-generator is further configured to supply power to the onboard storage medium.

10. A transfer case assembly for a vehicle powertrain having an engine having an engine crankshaft, a front drive shaft, a rear drive shaft, and an electric motor-generator, the transfer case assembly comprising:
a torque transfer housing defining:
a transfer case input port configured to receive a transfer case input member;
a first transfer case output port configured to receive a first transfer case output member, wherein the first transfer case output member is selectively couplable to the rear drive shaft; and
a second transfer case output port configured to receive a second transfer case output member, wherein the second transfer case output member is selectively couplable to the front drive shaft;
a two-way input/output port disposed opposite the second transfer case output port and configured to receive a two-way input/output extension member, wherein the two-way input/output extension member is disposed in parallel with the first transfer case output member and is further selectively couplable to the electric motor-generator; and
a plurality of axle disconnects configured to selectively couple and decouple the engine with each of the rear drive shaft, the front drive shaft, and the electric motor-generator and further configured to selectively couple and decouple the electric motor-generator with each of the front drive shaft and the rear drive shaft.

11. The transfer case assembly for a vehicle powertrain of claim 10 wherein the plurality of axle disconnects further comprises:
a first axle disconnect disposed between the first transfer case output member and the rear drive shaft, the first axle disconnect configured to selectively couple and decouple the first transfer case output member and the rear drive shaft;
a second axle disconnect disposed between the second transfer case output member and the front drive shaft, the second axle disconnect configured to selectively couple and decouple the second transfer case output member and the front drive shaft; and
a third axle disconnect disposed between the two-way input/output extension member and a motor-generator extension shaft, the third axle disconnect configured to selectively couple and decouple the two-way input/output extension member and motor-generator extension shaft.

12. The transfer case assembly for a vehicle powertrain of claim 11 wherein:
the electric motor-generator is configured to supply rotational torque to the two-way input/output extension member and receive torque from the two-way input/output extension member via the motor-generator extension shaft;
the electric motor-generator is electrically connected to an onboard storage medium, wherein onboard storage medium is defined as an onboard battery having from about fifty (50) kWhr to about one (1) MWhr of electrical power; and
the onboard storage medium configured to receive power from the electric motor-generator the two-way input/output extension member.

13. The transfer case assembly for a vehicle powertrain of claim 12 wherein the vehicle powertrain further comprises:
a transmission having a transmission input member that is operatively coupled to the engine crankshaft and a transmission output member operatively coupled to the transfer case input member;
a front axle in fluid communication with the front drive shaft via a front differential; and
a rear axle in fluid communication with the rear drive shaft via a rear differential.

14. The transfer case assembly for a vehicle powertrain of claim 13 wherein the vehicle powertrain further comprises a control unit in fluid communication with the engine, the transmission, the electric motor-generator, the plurality of axle disconnects, and the onboard storage medium, the control unit having a non-transitory computer readable medium that stores a set of computer executable instructions and at least one processor configured to execute the computer executable instructions embodied on the non-transitory computer readable medium, wherein the computer executable instructions cause the control unit and the processor to send signals to one of more of the plurality of axle disconnects to control a power flow of the vehicle powertrain in a plurality of operating modes.

15. The transfer case assembly of claim 14 wherein the plurality of operating modes comprises a direct power transfer operating mode, wherein in the direct power transfer operating mode the control unit simultaneously sends a first signal to the first axle disconnect to selectively decouple the first transfer case output member and the rear drive shaft, a second signal to the second axle disconnect to selectively decouple the second transfer case output member and the front drive shaft, and a third signal to the third axle disconnect to selectively couple the two-way input/output extension member and the motor-generator extension shaft; and
wherein the electric motor-generator is configured to receive rotational torque from the engine via the engine crankshaft, the transmission, the transmission output member, the transfer case input member, the torque transfer housing, the two-way input/output extension member, and the motor-generator extension shaft.

16. The transfer case assembly of claim 15 wherein the electric motor-generator is further configured to supply power to the onboard storage medium.

17. The transfer case assembly of claim 15 wherein the electric motor-generator is further configured to supply power to an external payload.

18. The transfer case assembly of claim 14 wherein the plurality of operating modes comprises a front-wheel drive auxiliary charge operating mode, wherein in the front-wheel-drive auxiliary charge operating mode the control unit simultaneously sends a first signal to the first axle disconnect to selectively decouple the first transfer case output member and the rear drive shaft, a second signal to the second axle disconnect to selectively couple the second transfer case output member and the front drive shaft, and a third signal to the third axle disconnect to selectively couple the two-way input/output extension member and the motor-generator extension shaft;
wherein the front axle is configured to drive the vehicle via rotational torque received from the engine via the engine crankshaft, the transmission, the transmission output member, the transfer case input member, the torque transfer housing, the second transfer case output member, the front drive shaft, and the front differential;
wherein electric motor-generator is configured to receive rotational torque from the engine via the engine crankshaft, the transmission, the transmission output member, the transfer case input member, the torque transfer housing, the two-way input/output extension member, and the motor-generator extension shaft; and
wherein the electric motor-generator is further configured to supply power to the onboard storage medium.

19. The transfer case assembly of claim 14 wherein the plurality of operating modes comprises a rear-wheel-drive auxiliary charge operating mode, wherein in a rear-wheel-drive auxiliary charge operating mode the control unit simultaneously sends a first signal to the first axle disconnect to selectively couple the first transfer case output member and the rear drive shaft, a second signal to the second axle disconnect to selectively decouple the second transfer case output member and the front drive shaft, and a third signal to the third axle disconnect to selectively couple the two-way input/output extension member and the motor-generator extension shaft; and
wherein the rear axle is configured to drive the vehicle via rotational torque received from the engine via the engine crankshaft, the transmission, the transmission output member, the transfer case input member, the torque transfer housing, the first transfer case output member, the rear drive shaft, and the rear differential;
wherein electric motor-generator is configured to receive rotational torque from the engine via the engine crankshaft, the transmission, the transmission output member, the transfer case input member, the torque transfer housing, the two-way input/output extension member and the motor-generator extension shaft; and
wherein the electric motor-generator is further configured to supply power to the onboard storage medium.

20. The transfer case assembly of claim 14 wherein the plurality of operating modes comprises an all-wheel drive auxiliary charge operating mode, wherein in the all-wheel drive auxiliary charge operating mode the control unit simultaneously sends a first signal to the first axle disconnect to selectively couple the first transfer case output member and the rear drive shaft, a second signal to the second axle disconnect to selectively couple the second transfer case output member and the front drive shaft, and a third signal to the third axle disconnect to selectively couple the two-way input/output extension member and the motor-generator extension shaft; and
wherein the front axle and rear axle are collectively configured to drive the vehicle, such that the rear axle is driven via rotational torque received from the engine via the engine crankshaft, the transmission, the transmission output member, the transfer case input member, the torque transfer housing, the first transfer case output member, the rear drive shaft and the rear differential and the front axle is driven via rotational torque received from the engine via the engine crankshaft, the transmission, the transmission output member, the transfer case input member, the torque transfer housing, the second transfer case output member, the front drive shaft, and the front differential;
wherein electric motor-generator is configured to receive rotational torque from the engine via the engine crankshaft, the transmission, the transmission output member, the transfer case input member, the torque transfer housing, the two-way input/output extension member and the motor-generator extension shaft; and
wherein the electric motor-generator is further configured to supply power to the onboard storage medium.
